(19) United States
(12) Patent Application Publication
(10) Pub. No.: US 2010/0159295 A1
(43) Pub. Date: Jun. 24, 2010

(54) ON-LINE REPLACEMENT OF DCFC TUBULAR ELEMENTS

(76) Inventors: RONALD WOLK, San Jose, CA (US); Iouri Balachov, Menlo Park, CA (US)

Correspondence Address: Wall & Tong, LLP;SRI INTERNATIONAL, 595 SHREWSBURY AVENUE, SHREWSBURY, NJ, 07702, US

(21) Appl. No.: 12/344,013

(22) Filed: Dec. 24, 2008

(51) Int. Cl. H01M 8/04; H01M 8/02

(52) U.S. Cl. 429/13; 429/12; 429/23

(57) ABSTRACT

In one embodiment, the present invention relates generally to a method for replacing at least one direct carbon fuel cell (DCFC) tube of a plurality of DCFC tubes in a fuel cell on-line. In one embodiment, the method includes detecting a degradation in performance of the at least one DCFC tube, removing the at least one DCFC tube while the fuel cell is still operating and providing a replacement DCFC tube while the fuel cell is still operating.

### FIELD OF THE INVENTION

The present invention relates generally to direct carbon fuel cells (DCFC) and a method and system for providing on-line replacement of DCFC tubular elements.

### BACKGROUND OF THE INVENTION

Currently, most fuel cell technology use stacks. For example, the stack may be built with alternating layers of repeating parts. As a result, when an individual fuel cell element within the stack fails, complete stack replacement is necessary.

Under the stack design, the entire system must be shut down for maintenance or to perform the stack replacement. For example, the fuel cell system is shut down to allow the entire system to cool. Then, the stack must be removed from the system and the failed fuel cell element may be repaired or replaced. Typically this process is very laborious requiring the entire fuel cell system to be shut down for days. The consequence for shutting down the fuel cell system and repairing or replacing an individual fuel cell element comes at an enormous cost.

### SUMMARY OF THE INVENTION

In one embodiment, the present invention is directed towards a method for replacing at least one direct carbon fuel cell (DCFC) tube of a plurality of DCFC tubes in a fuel cell on-line. In one embodiment, the method comprises detecting a degradation in performance of the at least one DCFC tube, removing said at least one DCFC tube while said fuel cell is still operating and providing a replacement DCFC tube while said fuel cell is still operating.

In one embodiment, the present invention is directed towards a fuel cell system. The fuel cell system comprises a fuel cell vessel holding a liquid anode, a thermal insulator coupled to said fuel cell vessel and a plurality of direct carbon fuel cell (DCFC) tubes inserted into said fuel cell vessel through said thermal insulator such that any one of the plurality of DCFC tubes are removable while said fuel cell system is operating.

In one embodiment, the present invention is directed towards a method for replacing at least one direct carbon fuel cell (DCFC) tube of a plurality of DCFC tubes in a fuel cell on-line. The method comprises detecting a degradation in performance of the at least one DCFC tube, removing said at least one DCFC tube while said fuel cell is still operating, re-furbishing said at least one DCFC tube and providing a refurbished DCFC tube while said fuel cell is still operating.

### BRIEF DESCRIPTION OF THE DRAWINGS

So that the manner in which the above recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a cross-sectional block diagram of an illustrative fuel system;

FIG. 2 depicts an illustrative graph of temperatures of a direct carbon fuel cell tube versus distance during extraction;

FIG. 3 depicts a flow diagram of one embodiment of a method for replacing a direct carbon fuel cell tube in a fuel cell; and

FIG. 4 depicts a flow diagram of an alternate embodiment of a method for replacing a direct carbon fuel cell tube in a fuel cell.

### DETAILED DESCRIPTION

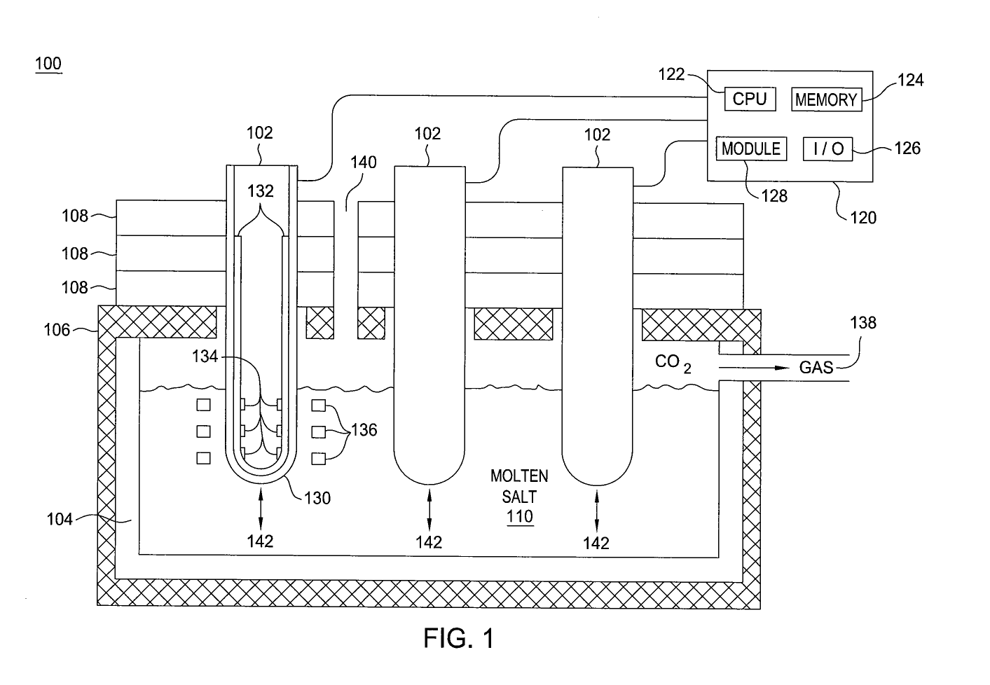

An illustrative fuel cell 100 of the present invention is illustrated in FIG. 1. In one embodiment, the fuel cell 100 comprises a plurality of direct carbon fuel cell (DCFC) tubes 102 inserted into a molten salt bath 110 in a vessel 104. Although FIG. 1 illustrates the use of three DCFC tubes 102, those skilled in the art will recognize that any number of DCFC tubes 102 may be used. Alternatively, the fuel cell 100 may comprise an array of vessels 104 each having one or more DCFC tubes 102.

In one embodiment, a thermal insulation layer 106 may be placed around the vessel 104. One or more holes may be provided in the thermal insulation layer 106 for removably inserting each one of the DCFC tubes 102. For example, a top view (not shown) of the fuel cell 100 may have multiple rows and columns of DCFC tubes 102 inserted through the thermal insulation layer 106. In addition, one or more removable thermal insulation layers 108 may be added on top of the thermal insulation layer 106. Arrows 142 indicate that the DCFC tubes 102 may slide up and down or in and out of the fuel cell 100 through the insulation layer 106 and the one or more removable thermal insulation layers 108.

The DCFC tubes 102 may be held in place by various means. For example, the DCFC tubes 102 may be held in place by mechanical means such as a clamp or a collar or by electrical or mechanical connections necessary for piping to deliver air or oxygen to the cathode. Carbon dioxide (CO₂) rich product gas is removed from the vessel 104 through a side penetration 138 and associated piping. Notably, the design of the fuel cell 100 and the way the DCFC tubes 102 are placed in the fuel cell 100 allow for each one of the one or more DCFC tubes 102 to be individually extracted and re-immersed without affecting the remaining DCFC tubes 102.

In one embodiment, the DCFC tubes 102 may comprise a solid electrolyte layer 130, a cathode layer 132 and one or more cathode current collectors 134. The solid electrolyte layer 130 may be any appropriate material used in fuel cell technology such as, for example, yttrium stabilized zirconia (YSZ), gadolinium doped ceria (GDC), scandia stabilized zirconia (ScSZ) and the like.

The vessel 104 may hold the molten salt bath 1 10 that provides a liquid anode and may comprises a molten salt or molten oxide chemistry along with dispersed carbon-rich fuel particles. For example, the salts may comprise eutectic mixtures of potassium carbonate (K₂CO₃), lithium carbonate (Li₂CO₃) and/or sodium carbonate (Na₂CO₃). The vessel 104 may also comprise one or more anode current collectors 136 suspended in the liquid anode. Although the details of only one of the DCFC tubes 102 are illustrated in FIG. 1, those skilled in the art will recognize that the configuration of the additional DCFC tubes 102 may be similar.

In one embodiment, the vessel 104 may include the side penetration 138 for removal of CO₂ product gas as discussed above. In addition, the vessel 104 may include one or more penetrations 140 through the removable insulation layers 108 and the thermal insulation layer 106 to allow solid, carbon-rich particulate fuel to be added to the molten salt bath 110.

One example of a fuel cell 100 that may be used in the present invention is provided in co-pending U.S. application Ser. No. 11/134,555, commonly assigned to SRI International, which is incorporated herein by reference. Those skilled in the art will recognize that the present invention is not limited to the fuel cells described herein and that the present invention may be applied to other similar types of fuel cells.

In one embodiment, each one of the DCFC tubes 102 may be monitored to track the performance of various parameters related to the DCFC tubes 102. Alternatively, groups of the DCFC tubes 102 may be monitored. For example, if the fuel cell 100 contains four DCFC tubes 102, the DCFC tubes 102 may be monitored in groups of two. By monitoring the DCFC tubes 102, when degradation of performance is detected in a DCFC tube 102 an alarm or notification may be generated to alert a technician or operator. The monitoring may be performed manually by a technician or operator or the monitoring may be automated.

In one embodiment of automated monitoring, each one of the DCFC tubes 102 may be coupled to at least one controller 120. For example, each one of the DCFC tubes 102 may have a separate controller 120 or all the DCFC tubes 102 may be coupled to a single controller 120. Alternatively, a controller 120 may be coupled to groups of DCFC tubes 102. For example, if the fuel cell 100 contains four DCFC tubes 102, a first group of two DCFC tubes 102 may be coupled to a first controller 120 and a second group of two DCFC tubes may be coupled to a second controller 120. Thus, in one embodiment, the controller 102 may monitor the performance of the group of DCFC tubes 102 rather than each individual tube.

In one embodiment as depicted in FIG. 1, the controller 120 may comprise a processor element 122 (e.g., a CPU), a memory 124, e.g., random access memory (RAM) and/or read only memory (ROM), various input/output devices 126 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)) and a module 128 for tracking performance of the DCFC tubes 102.

The module 128 may gather measurements of one or more parameters via sensors (not shown) coupled to each one of the DCFC tubes 102. For example, the parameters may be a measurement of a current output of the DCFC tube 102, a measurement of a resistance of the DCFC tube 102 or a measurement of a voltage of the DCFC tube 102. The module 128 may measure one or more of these parameters. Moreover, the module 128 is not limited to those parameters described herein and may measure other relevant parameters of the DCFC tube 102 that are not listed herein.

The controller 120 may monitor a performance of each one of the DCFC tubes 102 or groups of DCFC tubes 102, as described above, via the module 128. For example, the controller 120 may detect if there is degradation in performance of one of the DCFC tubes 102 or a group of the DCFC tubes 102. In one embodiment, the detection may occur if the controller 120 detects that a parameter has exceeded a predefined threshold. The parameter may be one of the parameters described above (e.g., current, resistance or voltage). In addition, more than one parameter each having a respective predefined threshold may be monitored. Thus, the present invention is not limited to only monitoring one parameter at a time.

In one embodiment, the predefined threshold may be a configurable parameter. For example, the predefined threshold may based upon an economic analysis of energy worth versus replacement cost or refurbishing costs of the DCFC tube 102. As a result, as the energy costs, replacement costs and/or refurbishing costs fluctuate, the predefined threshold may also fluctuate. For example, the predefined threshold may be set at 10% degradation in one or more of the above identified parameters in the DCFC tube 102. To illustrate by example, a baseline average of voltage of the DCFC tube 102 may be calculated. If the voltage of the DCFC tube 102 falls more than 10% from the calculated baseline average, the controller 120 may determine that the predefined threshold has been exceeded. However, as noted above, the predefined threshold may be configurable, such that the predefined threshold is 20%, 30% or 40% degradation in one or more of the above identified parameters. In addition, each one of the DCFC tubes 102 may have the same or different predefined thresholds.

When the controller 120 detects that the predefined threshold is breached or exceeded, the controller 120 may trigger an alarm, warning or notification that indicates or identifies one or more particular DCFC tubes 120 suffering the degradation in performance. As a result, a technician or operator may be informed of the one or more particular DCFC tubes 120 that have the degradation in performance past an acceptable limit. Alternatively, an automated machine such as a robotic arm may be notified of the one or more particular DCFC tubes 120 that have the degradation in performance past an acceptable limit.

One advantage of the present invention is that the DCFC tubes 102 may be replaced while the fuel cell 100 is still operating. As a result, the fuel cell system does not need to be shut down for extended periods of time (e.g., days, weeks or months) to replace any of the elements or DCFC tubes 102 of the fuel cell 100. As a result, the present invention provides a substantial cost savings and improves operating efficiency.

In one embodiment, to remove any one of the DCFC tubes 102, the DCFC tube 102 must be removed in a controlled manner. For example, the DCFC tube 102 must be removed at a specific rate, which may be a function a material of the DCFC tube 102, a geometry of the DCFC tube 102 and/or a temperature of the DCFC tube.

The material of the DCFC tube 102 determines a value of the coefficient of thermal expansion and thermal shock resistance constants. Each material has a unique coefficient of thermal expansion and thermal shock resistance constant. As a result, different materials may cool at different rates or have different temperature gradient profiles. The values may be provided by vendors of the materials used for the DCFC tube 102. As a result, a range of the acceptable extraction rates may be calculated for each material based upon the values of the coefficient of thermal expansion and/or thermal shock resistance constants of the material used for the DCFC tube 102. The temperature parameter includes measurements of temperature gradients across the DCFC tube 102.

Notably, the rate of extraction may be any rate such that the DCFC tube 102 does not crack upon extraction. The rate may vary based upon the type of material that is used for the DCFC tube 102 as described above. In one embodiment, the extraction speed may be approximately 0.2 centimeters (cm)/minute (min)-2.0 cm/min. The rate of removal controls the range of temperature change of the DCFC tube 102. The rate may be controlled such that the DCFC tube 102 does not crack during extraction due to rapid change in the temperature gradients across the DCFC tube 102 (i.e. from cooling too rapidly).

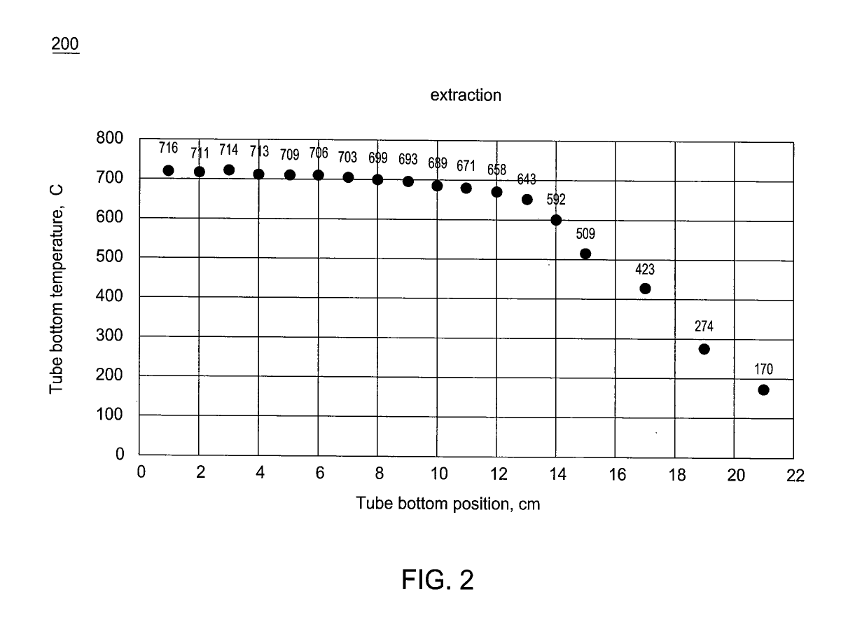

In one embodiment, a DCFC tube 102 approximately 30 centimeters long having a diameter of approximately 1.6 cm having a YSZ electrolyte and lanthanum strontium manganite (LSM) cathode was extracted “on-line” while operating at approximately 700 Celsius (° C.). The tube was extracted at a rate of approximately 0.2 cm/min to 1 cm/min. FIG. 2 illustrates a graph 200 of intermittent temperature measurements of the DCFC tube 102 during extraction. The graph 200 illustrates tube bottom temperature (° C.) versus tube bottom position (cm) relative to the vessel 104. As can be seen by graph 200, the rate may initially start very slowly to control temperature gradients in the DCFC tube 102 and prevent cracking and then increase as the DCFC tube 102 moves further away from the bottom of the vessel 104.

The removable thermal insulation layers 108, illustrated in FIG. 1, may be used to control axial temperature gradients. As illustrated in FIG. 1, one or more removable thermal insulation layers 108 may be used.

Using the above novel method, the extracted DCFC tube 102 was found to have no cracks when viewed under an optical microscope. The DCFC tube 102 may then be re-furbished or a new DCFC tube may be re-immersed into the fuel cell 100. The re-immersion may occur at a rate similar to the rate of extraction. For example, the new DCFC tube may be re-immersed at a rate of approximately 0.2 cm/min-2.0 cm/min.

In one embodiment, a new DCFC tube was re-immersed at a rate of approximately 0.2 cm/min to 1 cm/min. The new DCFC tube was immersed and tested for 1,000 hours at open circuit voltage with periodic current-voltage measurements. No voltage degradation was observed for the new DCFC tube. Peak power degradation was approximately 8% over 1,000 hours.

Thus, the above described novel method and system for on-line removal of DCFC tubes in a fuel cell provides costs savings by limiting down time of the fuel system. For example, removing one of many DCFC tubes in the fuel cell 100 will have minimal impact on overall voltage or power output of the fuel cell 100. Thus, the DCFC tubes 102 may be replaced on-line, i.e. while the fuel cell 100 is still operating. On-line DCFC tube replacement reduces concerns about tube life-time. As a result, tube life-time targets may be based on “mean time between services” instead of “system lifetime”.

As discussed above, the DCFC tube 102 may be refurbished after extraction and re-immersed. For example, to refurbish the DCFC tube 102, the solid electrolyte layer 130 may be re-applied to the DCFC tube 102 or replaced. As a result, the decision to either immerse a new DCFC tube or to immerse a refurbished DCFC tube may depend on a cost of a new DCFC tube verses a cost of materials needed to refurbish the DCFC tube.

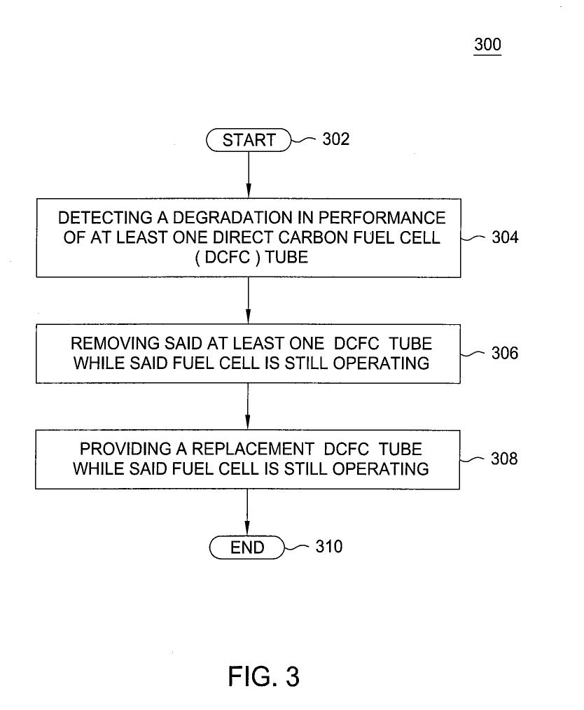

FIG. 3 illustrates a flow diagram of one embodiment of a method 300 for replacing at least one direct carbon fuel cell (DCFC) tube of a plurality of DCFC tubes in a fuel cell online. In one embodiment, the method 300 may be carried out for example on any one of the DCFC tubes 102 of the fuel cell 100 described above and illustrated in FIG. 1. Moreover, any number of DCFC tubes may be removed as long as there is at least one DCFC tube remaining for the fuel cell to continue operating. For example, if there are three DCFC tubes in the fuel cell, up to two DCFC tubes may be removed. Alternatively, if the fuel cell is configured with multiple vessels 104 each having one or more DCFC tubes arranged in an array, then all of the DCFC tubes within any one vessel 104 may be removed.

The method 300 begins at step 302. At step 304, the method 300 detects a degradation in performance of the at least one DCFC tube. As discussed above, the degradation may be detected by a controller 120 described above by measuring one or more various parameters such as current, voltage, resistance and the like.

At step 306, the method 300 removes the at least one DCFC tube while said fuel cell is still operating. In other words, the DCFC tube may be removed “on-line”. The DCFC tube may be removed at a predefined rate, as described above.

At step 308, the method 300 provides a replacement DCFC tube while the fuel cell is still operating. As discussed above, the replacement DCFC tube may be either a new DCFC tube or a refurbished DCFC tube. The method 300 concludes at step 310.

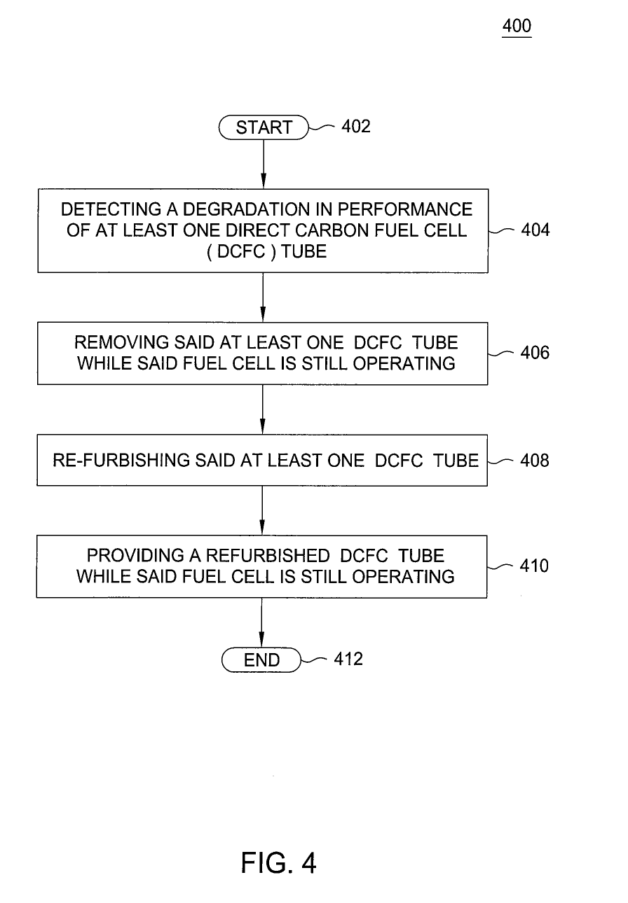

FIG. 4 illustrates a flow diagram of an alternate embodiment of a method 400 for replacing at least one direct carbon fuel cell (DCFC) tube of a plurality of DCFC tubes in a fuel cell online. In one embodiment, the method 400 may be carried out for example on any one of the DCFC tubes 102 of the fuel cell 100 described above and illustrated in FIG. 1. Moreover, any number of DCFC tubes may be removed as long as there is at least one DCFC tube remaining for the fuel cell to continue operating. For example, if there are three DCFC tubes in the fuel cell, up to two DCFC tubes may be removed. Alternatively, if the fuel cell is configured with multiple vessels 104 each having one or more DCFC tubes arranged in an array, then all of the DCFC tubes within any one vessel 104 may be removed.

The method 400 begins at step 402. At step 404, the method 400 detects a degradation in performance of the at least one DCFC tube. As discussed above, the degradation may be detected by a controller 120 described above by measuring one or more various parameters such as current, voltage, resistance and the like.

At step 406, the method 400 removes the at least one DCFC tube while said fuel cell is still operating. In other words, the DCFC tube may be removed “on-line”. The DCFC tube may be removed at a predefined rate, as described above.

At step 408, the method 400 refurbishes the at least one DCFC tube. For example, as described above, the solid electrolyte layer of the DCFC tube may be regenerated or replaced.

At step 410, the method 400 provides a refurbished DCFC tube while the fuel cell is still operating. The method 400 concludes at step 412.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for replacing at least one direct carbon fuel cell (DCFC) tube of a plurality of DCFC tubes in a fuel cell on-line, comprising:
detecting a degradation in performance of said at least one DCFC tube;
removing said at least one DCFC tube while said fuel cell is still operating; and
providing a replacement DCFC tube while said fuel cell is still operating.

2. The method of claim 1, wherein said detecting comprises:
receiving an indication that a parameter has exceeded a predefined threshold.

3. The method of claim 2, wherein said parameter is at least one of: a measured current output of said DCFC tube, a measured resistance of said DCFC tube or a measured voltage of said DCFC tube.

4. The method of claim 2, wherein said predefined threshold is configurable.

5. The method of claim 2, wherein said predefined threshold is based upon an economic analysis of energy worth versus replacement cost of said at least one DCFC tube.

6. The method of claim 1, wherein said removing comprises:
removing said at least one DCFC tube at a predefined rate.

7. The method of claim 6, wherein said predefined rate is a function of at least one of: a material of said DCFC tube, a geometry of said DCFC tube or a temperature of said DCFC tube.

8. The method of claim 7, wherein said temperature of said at least one DCFC tube comprises temperature gradients of said at least one DCFC tube.

9. The method of claim 1, wherein said replacement DCFC tube comprises said at least one DCFC tube that has been refurbished or a new DCFC tube.

10. A fuel cell system, comprising:
a fuel cell vessel holding a liquid anode;
a thermal insulator coupled to said fuel cell vessel; and
a plurality of direct carbon fuel cell (DCFC) tubes inserted into said fuel cell vessel through said thermal insulator such that any one of the plurality of DCFC tubes are removable while said fuel cell system is operating.

11. The fuel cell system of claim 10, further comprising:
at least one controller coupled to each one of said plurality of DCFC tubes for detecting a degradation in performance of a respective one of said plurality of DCFC tubes.

12. The fuel cell system of claim 11, wherein said detecting comprises:
receiving an indication that a parameter has exceeded a predefined threshold.

13. The fuel cell system of claim 12, wherein said parameter is at least one of: a measured current output of a DCFC tube, a measured resistance of a DCFC tube or a measured voltage of a DCFC tube.

14. The fuel cell system of claim 12, wherein said predefined threshold is configurable.

15. The fuel cell system of claim 12, wherein said predefined threshold is based upon an economic analysis of energy worth versus replacement cost of said DCFC tube.

16. The fuel cell system of claim 10, wherein said plurality of DCFC tubes are removable at a predefined rate.

17. The fuel cell system of claim 16, wherein said predefined rate is a function of at least one of: a material of a DCFC tube, a geometry of a DCFC tube or a temperature of a DCFC tube.

18. The fuel cell system of claim 10, wherein said plurality of DCFC tubes is held in place via at least one of: a collar, a clamp, an electrical connection or a mechanical connection.

19. A method for replacing at least one direct carbon fuel cell (DCFC) tube of a plurality of DCFC tubes in a fuel cell on-line, comprising:
detecting a degradation in performance of said at least one DCFC tube;
removing said at least one DCFC tube while said fuel cell is still operating;
re-furbishing said at least one DCFC tube; and
providing a refurbished DCFC tube while said fuel cell is still operating.

20. The method of claim 19, wherein re-furbishing said at least one DCFC tube comprises regenerating or replacing a solid electrolyte layer of said at least one DCFC tube.
